(19) United States
(12) Patent Application Publication
(10) Pub. No.: US 2005/0149251 A1
(43) Pub. Date: Jul. 7, 2005

(54) Real time high accuracy geospatial database for onboard intelligent vehicle applications

(75) Inventors: Max Donath, St. Louis Park, MN (US); Bryan Newstrom, Circle Pines, MN (US); Craig R. Shankwitz, Minneapolis, MN (US); Alec Gorjestani, Minneapolis, MN (US); Heonmin Lim, Sammamish, WA (US); Lee Alexander, Woodbury, MN (US)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: University of Minnesota, Minneapolis, MN (US)

(21) Appl. No.: 10/969,806

(22) Filed: Oct. 20, 2004

Related U.S. Application Data
(63) Continuation of application No. 10/091,182, filed on Mar. 5, 2002.
(63) Continuation-in-part of application No. 09/618,613, filed on Jul. 18, 2000.
(60) Provisional application No. 60/273,419, filed on Mar. 5, 2001.

(51) Int. Cl. G01C 21/26

(52) U.S. Cl. 701/200; 701/208; 340/995.14

(57) ABSTRACT

A geospatial database management system includes a geospatial database containing data elements that identify locations of a plurality of road features of a tangible road. The road features are displaced from each other in a widthwise direction that is transverse to the road.

The present application is a continuation of U.S. patent application Ser. No. 10/091,182, filed Mar. 5, 2002, which in turn is based on and claims the benefit of U.S. provisional patent application Ser. No. 60/273,419, filed Mar. 5, 2001; and the present application is also a continuation-in-part of U.S. patent application Ser. No. 09/618,613, filed Jul. 18, 2000, and entitled MOBILITY ASSIST DEVICE. The contents of all of the above-referenced applications are hereby incorporated by reference in their entirety.

### BACKGROUND OF THE INVENTION

The present invention relates to a driver assist system. More specifically, the present invention relates to a real time accessible geospatial database that can be used with driver assist subsystems.

Geographic information systems (GIS) are systems that are used to store and manipulate geographic data. GIS is primarily used for collection, analysis, and presentation of information describing the physical and logical properties of the geographic world. A system referred to as GIS-T is a subset of GIS that focuses primarily on the transportation aspects of the geographic world. There have been many products developed that provide drivers with route and navigation information. Some automobile manufacturers provide onboard navigation systems.

However, these systems are based on conventionally designed and commonly used digital maps that are navigatable road network databases, covering various geographic regions. Such maps are designed for turn-by-turn, and door-by-door route guidance which can be used in conjunction with a global positioning system (GPS) unit and a display for providing route assistance to a driver.

Such conventionally designed digital maps usually refer to digital road networks that are typically set up to do routing, geocoding, and addressing. In a road network, every intersection in a map is a node and the links are the roads connecting the nodes. There are also intermediate nodes that define link (road) geometry. These systems tend to employ a linear referencing system—that is, the location of nodes are defined relative to other nodes, and intermediate attributes are defined relative to a distance from a node (e.g., the speed limit sign is 5 miles along this specified road/link starting from this specified intersection/node).

Some existing maps have been adapted to assist onboard “intelligent” vehicle systems. For example, an autonomous van with computer controlled steering, throttle, brakes and direction indicators has been developed. The lateral guidance for the van was aided by knowledge of road curvatures stored in a digital road map database. Cameras were positioned to look at various angles away from the van. The road geometry was used to determine which camera would have the best view of the road for driving.

Another autonomous vehicle control was augmented with a digital map as well. In that instance, video cameras, ultrasonic sensors and a three-dimensional scanning laser range finder were used along with a differential GPS system to control and navigate an autonomous vehicle. A three-dimensional map was used to compensate for the inaccuracies of the DGPS system.

Similarly, digital road map databases have been used to help in collision avoidance. The map databases were used to detect when the vehicle was approaching an intersection and to provide the angles of adjoining roadways to aim radar.

Similarly, a digital railway map has been used in the field of positive train control. The map was similar to a road network database and was used to calculate braking distances and make enforcement decisions for automatic brake control of a train.

All of the above-described systems discuss the use of conventionally designed digital road maps to augment the workings of onboard vehicle systems. However, they are limited to the simple road map information in conventional digital maps, augmented with a small amount of additional information.

Existing digital road network databases, although becoming more prevalent, simply do not have adequate resolution, accuracy or access times for intelligent vehicle applications developed for real time driver assistant technologies. For example, in European and Japanese urban areas, map scales for route guidance and map matching may need to be 1:10,000, while in rural areas, the map scales may only need to be 1:50,000. The urban areas require a higher resolution since the infrastructure density is greater.

However, the map scale needed for a real time driver assist system approaches 1:1—that is, what is in the database must substantially exactly correspond to what is in the real world.

### SUMMARY OF THE INVENTION

The present invention is directed to a geospatial database management system that manages geospatial data relating to a vehicle travel path having one or more lanes. The geospatial database management system includes a geospatial database containing data elements that identify locations of a plurality of road features of a tangible road. The road features are displaced from each other in a widthwise direction that is transverse to the road.

Additional embodiments of the geospatial database management system of the present invention include a driver assist subsystem component that is supported on the motor vehicle, a database manager component, and a query processor. The driver assist subsystem component is configured to assist a driver of the motor vehicle based on the locations identified by the data elements of the geospatial database. The database manager component is configured to maintain the locations identified by the data elements of the geospatial database and receive database queries from the driver assist subsystem. The query processor is configured to receive the database queries from the database manager component, query the geospatial database based on the database queries and return query results to the database manager component.

Other features and benefits that characterize embodiments of the present invention will be apparent upon reading the following detailed description and review of the associated drawings.

### BRIEF DESCRIPTION OF THE DRAWINGS

FIG. 1 is a block diagram of a geospatial database management system in accordance with one embodiment of the present invention.

FIG. 2 illustrates how some data types are modeled in accordance with one embodiment of the present invention.

FIG. 3 illustrates one model for representing objects in the database in accordance with one embodiment of the present invention.

FIG. 4 is a flow diagram illustrating the operation of the system shown in FIG. 1 in accordance with one embodiment of the present invention.

FIG. 5 illustrates the intersection of a query polygon with tiles in a database in accordance with one embodiment of the present invention.

FIG. 6 illustrates searching identified tiles for specified and intersecting objects in accordance with one embodiment of the present invention.

FIG. 7 is a block diagram of a subsystem in accordance with embodiments of the invention.

FIG. 8 is a more detailed block diagram of another embodiment of the subsystem provided in FIG. 7.

FIG. 9A is a partial-pictorial and partial-block diagram illustrating operation of a subsystem in accordance with embodiments of the invention.

FIG. 9B illustrates the concept of a combiner and virtual screen.

FIGS. 9C-9E are pictorial illustrations of a conformal, augmented projection and display in accordance with embodiments of the invention.

FIGS. 9F-9I are pictorial illustrations of an actual conformal, augmented display of a subsystem in accordance with embodiments of the invention.

### DETAILED DESCRIPTION OF THE PREFERRED EMBODIMENTS

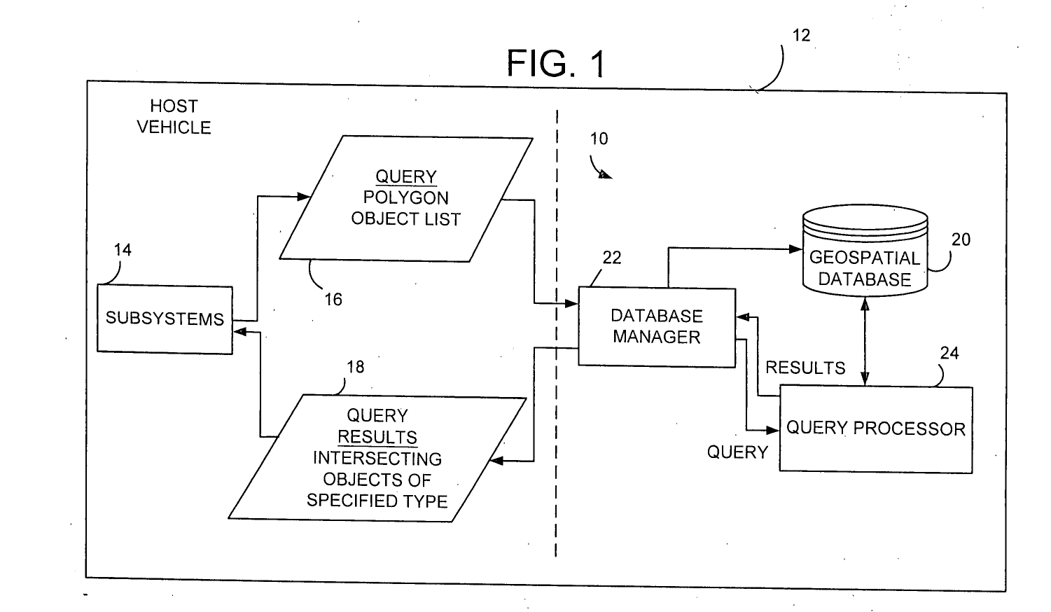

FIG. 1 is a block diagram of a geospatial database management system 10 to be used on a host vehicle 12 with one or more onboard intelligent subsystems 14 (such as driver assist subsystems). Subsystems 14 illustratively assist the driver of vehicle 12 in a variety of different ways. By way of example, subsystems 14 may provide an operator interface which conveys information to the operator indicative of the position of vehicle 12 within a lane of traffic, and also indicate to the driver information about objects around the vehicle.

In order to convey that information to the user, subsystems 14 provide a query 16 to database management system 10 and receive query results 18. The query results can indicate the location of a wide variety of objects relative to vehicle 12.

While the present invention does not depend on the particular type of subsystem 14 being used, a number of those subsystems will now be described in a bit greater detail to enhance understanding of the present invention. In one embodiment, subsystems 14 include a head-up display and radar filter that work together to create a virtual representation of the views out the windshield that allow the operator to safely maneuver the vehicle in impaired or low visibility conditions. Subsystems 14 can also include a virtual mirror or other vision assist system that creates a virtual representation of views looking in different directions from vehicle 12. Subsystems 14 also illustratively include a virtual rumble strip that provides a haptic feedback through the steering wheel, brake pedals, the seat, etc. to give the operator a sense of the vehicle position within a current lane.

The road information used by each of these subsystems is illustratively maintained in a geospatial database 20 by a database manager 22. The information is retrieved from geospatial database 20, through database manager 22, by query processor 24.

Some specific examples of subsystems 14 will now be discussed for the sake of clarity only. The head-up display is described in greater detail in U.S. patent application Ser. No. 09/618,613. Briefly, however, the head up display provides a vehicle operator with a virtual roadway view when the view of the real road is impaired or blocked. This system works by creating a computer-generated image of the current lane boundaries as seen through the windshield from the driver's eye perspective. In one embodiment, the operator looks through a combiner, which is a spherical semi-reflective semi-transmissive piece of optical ground and coated glass or optical grade plastic, that combines the computer-generated image and the actual view out the windshield. The head-up display subsystem is calibrated so that the virtual roadway overlays the real roadway.

The radar target filtering subsystem is also described in greater detail in the above-identified patent application. Briefly, however, the subsystem works in conjunction with the head-up display. Radar is mounted on vehicle 12 to detect objects in a vicinity of vehicle 12. When the radar detects an object, it passes the location of the object to the head-up display which then draws an icon to represent that object in the correct location and size to overlay the object. Due to the size of the field of view of the radar system, the radar may detect signs, trees and other objects that are either off the road surface or pose no threat of collision. To reduce the number of detected objects to display, known objects that do not pose a threat are filtered and not displayed to the driver. The objects that are filtered are usually off the road, beyond the road shoulder, in a traffic island, or in a median. Filtering is performed by comparing the location of detected objects to the road geometry in the same region. If the filter determines that the detected objected is on the roadway or shoulder, then the head-up display displays an icon to represent the detected object. Objects on the shoulder are presented within the head-up display since they may present an abandoned vehicle or other potential obstacle to the driver.

The virtual rumble strip generates haptic feedback that provides a “feel” of the road to the driver by imposing, for example, a reactive torque as a function of positional change relative to the road geometry. Thus, for example, the lane boundary can be made to feel like a virtual wall or hump, which the driver must overcome in order to change lanes. This subsystem can simulate the action of a real rumble strip. As the vehicle moves toward either lane boundary, to the left or the right of the vehicle, the steering wheel can oscillate as if the vehicle is driving over a real rumble strip. The process controlling a servomotor (that imparts the oscillation and is attached to the steering wheel shaft) first determines the lateral offset between the vehicle's position and the center of the current lane. Once the lateral offset crosses a preset limit, the motor oscillates the steering wheel. Of course, unlike a physical rumble strip, the virtual rumble strip can change the amount of “rumble” as the vehicle moves. Thus, as the operator drifts further from the center line, the virtual rumble strip may increase oscillation giving the operator a sense of which direction to steer back to the center of the lane.

The objects or data types that are used within geospatial database 20 are modeled on actual road infrastructure. Together, the different data types comprise the data model that defines the objects within the database, and how the different objects relate to one another. Since each of the different subsystems 14 require different information about the same stretch or roadway, the data model can be tailored to the particular subsystems 14.

In one illustrative embodiment, all data types are based on four basic spatial data types: point, line-string, arc-segment and polygon. The most basic spatial type is the point, and all other spatial types are comprised of points. All points include three-dimensional location data, such as either an X, Y and Z component or latitude, longitude, and elevation components. Line-strings are a list of points that represent continuous line segments, and arc-segments are line-strings that represent a section of a circle. Any arc includes a series of points that lay on a circle, with a given center point. A polygon is a closed line string with the first and last points being the same.

Direction is an important component of road information. Direction has been captured by the ordering of the points within the spatial objects. The direction of any road object is defined by the direction of traffic, and is captured by its spatial representation. In other words, the first point within the object is the first point reached while driving and the second point is the second point reached, and so on, while moving in the normal direction of traffic. This encoded order makes the direction inherent in the object and removes the need to store the direction as an attribute outside of the spatial data.

Each of the onboard subsystems 14 has specific data types that represent the data it needs. Included with each data type are attributes that identify other non-spatial properties. To simplify the objects within the database, their non-spatial attributes are illustratively specific for their spatial data type. Within geospatial database 20, all the attribute processing is done during the database creation process. If an attribute changes along a spatial object, then the original object is illustratively split into two smaller objects keeping the attributes static.

In one illustrative embodiment, included within the line-string based objects are attributes that can be used to reconstruct continuous line-string segments from its parts. Using these attributes, the original line-string can be reconstructed from the line-string segments that were split off due to attribute changes. Each new component line-string has an identification (ID) number that uniquely identifies that line-string within a unique group. All line-strings that make up a larger line-string are part of the same group. Within geospatial database 20, each line-string based object is uniquely identified by its group and ID within that group. Also included is a previous ID and a next ID that are attributes which describe how each individual line-string fits into the larger line-string, or what the next and previous line-strings are.

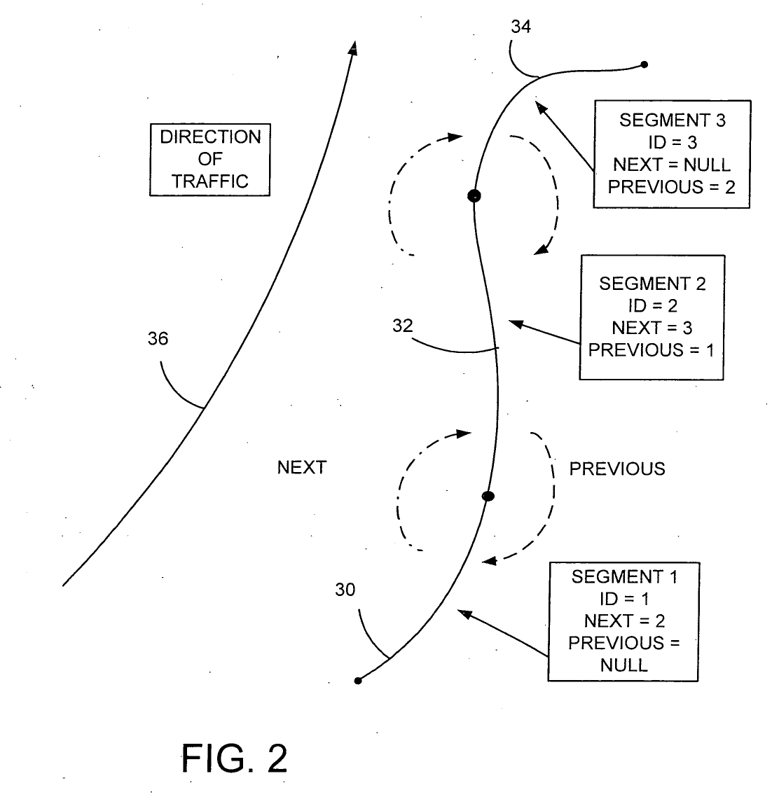

FIG. 2 is a depiction of such line-string based objects. FIG. 2 shows three line-string segments 30, 32 and 34. Such segments, when joined together as shown in FIG. 2, may illustratively represent a road boundary, center line, etc., with a direction of traffic generally indicated by arrow 36. FIG. 2 also illustrates the objects 28, 40 and 42 corresponding to segments 30, 32 and 34, with their associated attributes. The attributes, for example, include a segment number, an ID, a next line segment in the group, and a previous line segment in the group. It can thus be seen how the line segments can be reassembled to make one single line segment corresponding to the segments of a single group.

A number of specific data types will now be discussed for the previously-mentioned subsystems 14, for exemplary purposes only. It will, of course, be understood that a wide variety of other data types can be stored in geospatial database 20 as well.

The head-up display may illustratively include a LaneBoundary data type and a calibration mark (CalMark) data type. The LaneBoundaries are the left and right most limits to each individual lane and may correspond to the painted lane or line markings to the right and left of a lane. The head-up display projects the LaneBoundaries correctly so that they overlay the actual lane markings.

The LaneBoundary object is based on the line-string spatial data type. Each LaneBoundary is between two lanes, a lane to the right and a lane to the left, where left and right is relative to the direction of traffic. The direction property of the LaneBoundary is captured within its attributes.

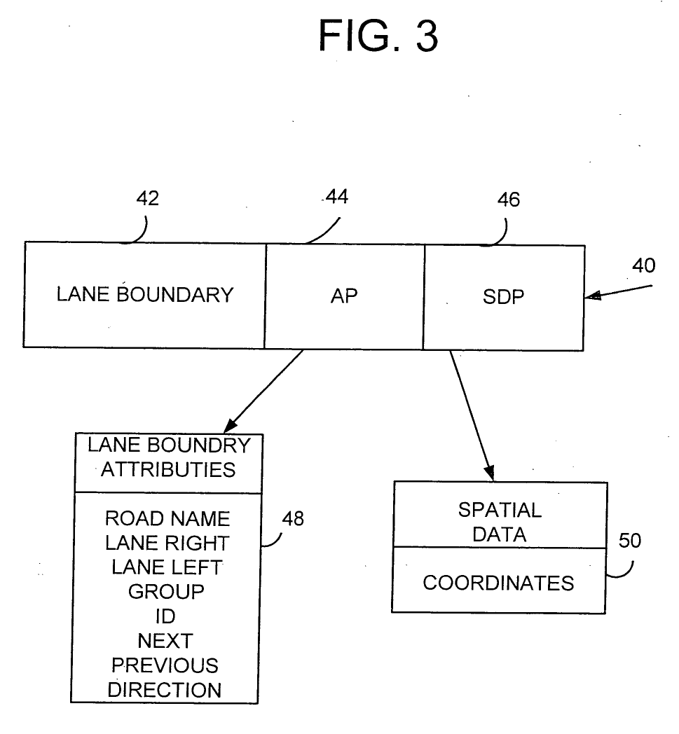

FIG. 3 illustrates a LaneBoundary object, and one illustrative way that it is organized within geospatial database 20. In one illustrative embodiment, the LaneBoundary object includes a first entry 40 in database 20 which has an object type identifier section 42 that identifies the object type, along with a pair of pointer sections 44 and 46. Pointer 44 illustratively contains an attributes pointer (AP) that points to a location within geospatial database 20 that contains the attributes 48 associated with the LaneBoundary object identified by identifier 42. Pointer 46 illustratively contains a spatial data pointer (SDP) that points to a location within geospatial database 20 that contains the spatial data 50 corresponding to the LaneBoundary object identified by identifier 42. The spatial data, as discussed above, will illustratively include X, Y and Z coordinates or longitude, latitude and elevation coordinates, or any other coordinates that identify the location of the particular object referred to.

The attributes 48 may also include the name and direction of the roadway of which the LaneBoundary is a part, wherein the direction attribute refers to the overall compass direction which may, for example, be included in the road name such as the “West” in “Interstate 94 West”. This means that the object is found in the West bound lane or lanes of Interstate 94. Of course, it is also possible to add attributes to the object that describe the actual lane marking applied to the roadway (e.g., double line, single and skip line, yellow or white colored lines, etc.) following acceptable lane marking standards.

The head-up display subsystem 14 may also include the CalMark object that is used during calibration of the head-up display. Normally, these represent simple geometric figures painted on the roadway and are based on the line-string data type. The attributes may illustratively include a unique ID number and the name of the road with which it is associated with. The CalMark object may not be needed during operation of the system.

The radar target filtering subsystem 14 illustratively includes a RoadShoulder object and a RoadIsland object, while the virtual rumble strip subsystem 14 illustratively includes a LaneCenter object. RoadShoulders are illustratively defined as the boundary of any driveable surface which corresponds to the edge of pavement and may correspond to any painted stripes or physical barrier. The target filter uses this object to determine whether detected objects are on the road surface. RoadShoulders are based on the line-string data type and can be on one or both sides of the roadway, which is captured by an attribute. Table 1 shows the attributes of the RoadShoulder object.

TABLE 1
RoadShoulder
Road Name
Group
Id
Next
Previous
Direction
Side

RoadIslands are areas contained within RoadShoulders, or within the roadway, that are not driveable surfaces. Once the radar target filter has determined that an object is on the road, or between the RoadShoulders, then the filter compares the location of the detected object against RoadIslands to determine whether the object is located within a RoadIsland, and can be ignored. Table 2 shows illustrative attributes of the RoadIsland object.

TABLE 2
RoadIsland
Road Name
Id

LaneCenters are defined as the midpoint between the LaneBoundaries of the lane. The virtual rumble strip computes a lateral offset from the LaneCenter to be used for determining when to oscillate the steering wheel for undesired lane departure. The individual segments of a LaneCenter object can either be a straight line or a section of a circle. Each LaneCenter object captures the properties of a single lane, including direction and speed limit. Table 3 illustrates attributes of a LaneCenter object.

TABLE 3
LaneCenter
Road Name
Lane
Group
Id
Next
Previous
Direction
Speed

It can be seen that, within the attributes for the LaneCenter object, there is a unique lane number that is the same number used within the LaneBoundaries, and there are also left and right attributes.

Warnings of lane departure such as the use of steering wheel vibrations or oscillations can also be determined by other more complex algorithms, such as the Time to Lane Crossing (TLC) approach, where parameters used in the algorithm are determined from the vehicle's speed, position and orientation relative to the Lane Center, or relative to the-Road shoulder, or relative to the Lane Boundaries attribute, or relative to any new attribute or one identified relative to these, and from the steering wheel or steered wheel angle.

It should also be noted that many other objects could also be used. For example, such objects can be representative of mailboxes, jersey barriers, guard rails, bridge abutments, tunnel walls, ground plane and ceiling, curbs, curb cutouts, fire hydrants, light posts, traffic signal posts, sign and sign. posts and other structures adjacent to the road or pathway, as needed. Furthermore, each object may have a drawing attribute or set of attributes that describe how to draw it in a display.

Of course, it should also be noted that these data types are specific to vehicles traveling on roads. Other data types will be used in other applications such as aircraft or other vehicles traveling on an airport tarmac or in the air, vehicles travelling on or under the water, construction equipment, snowmobiles, or any of the other applications mentioned in the incorporated references.

It will be appreciated from the description of subsystems 14, that each of them needs to continually update the geospatial database information received from system 10 to accommodate vehicle motion. As vehicle 12 moves, the field of view of each subsystem 14 changes and the information previously retrieved from geospatial database 20 is no longer valid.

In database management system 10, database manager 22 and query processor 24 work together to provide access to the road information stored within geospatial database 20. Database manager 22 maintains the database and is a gateway to query processor 24.

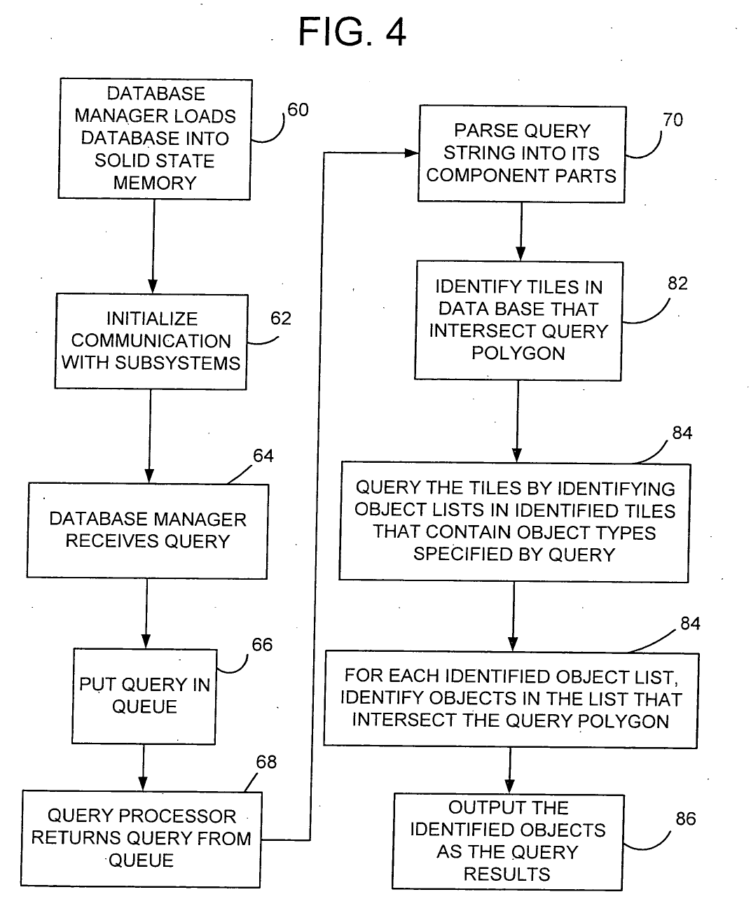

FIG. 4 is a flow diagram that better illustrates the operation of the system. When database manager 22 is first initialized, it loads database 20 into solid state memory. Of course, it should be noted that, where database 20 is extremely large, database manager 22 can simply load a relevant portion of the database into solid state memory, such as a portion of the database corresponding to a 50 mile radius around a current geographic location. Loading the database into memory is indicated by block 60 in FIG. 4.

Database manager 22 then initializes communication with subsystems 14. This is indicated by block 62. Database manager 22 then simply waits for a query 16.

In generating a query 16, each of the subsystems 14 provide a predefined query structure. The query structure illustratively contains a query polygon and a character string describing the desired object types with desired attributes or attribute ranges. The query polygon is the area of interest (such as the area around or in front of vehicle 12) to the particular subsystem generating the query. Database manager 22 receives the query as indicated by block 64 and places the query in a query queue as indicated by block 66. When query processor 24 is ready to process the next query, it retrieves a query from the query queue as indicated by block 68, and parses the query into its component parts, as indicated by block 70.

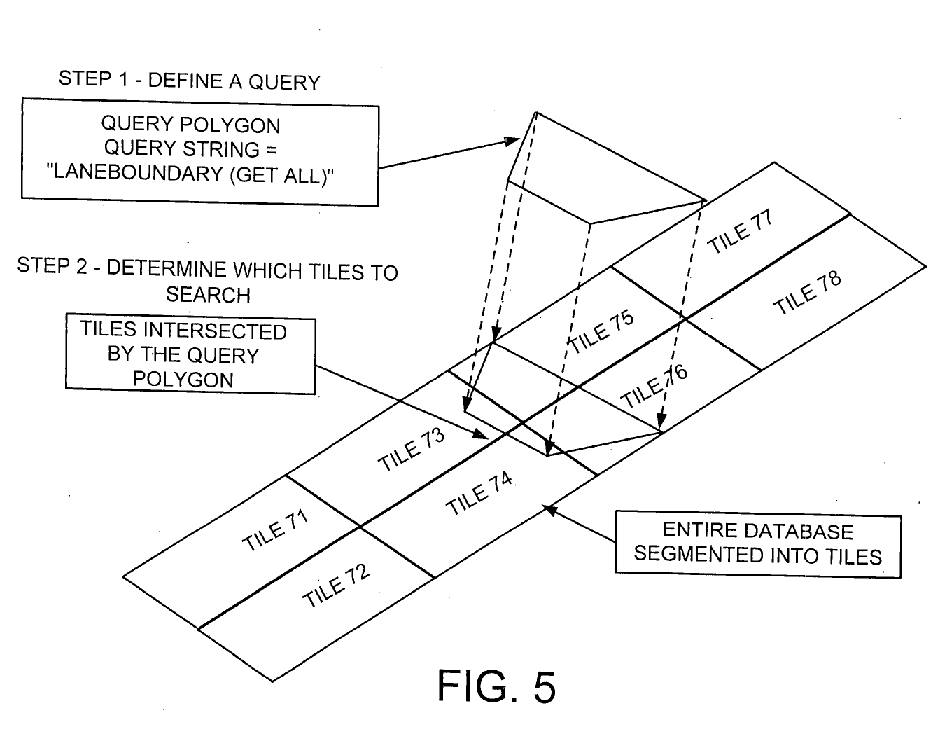

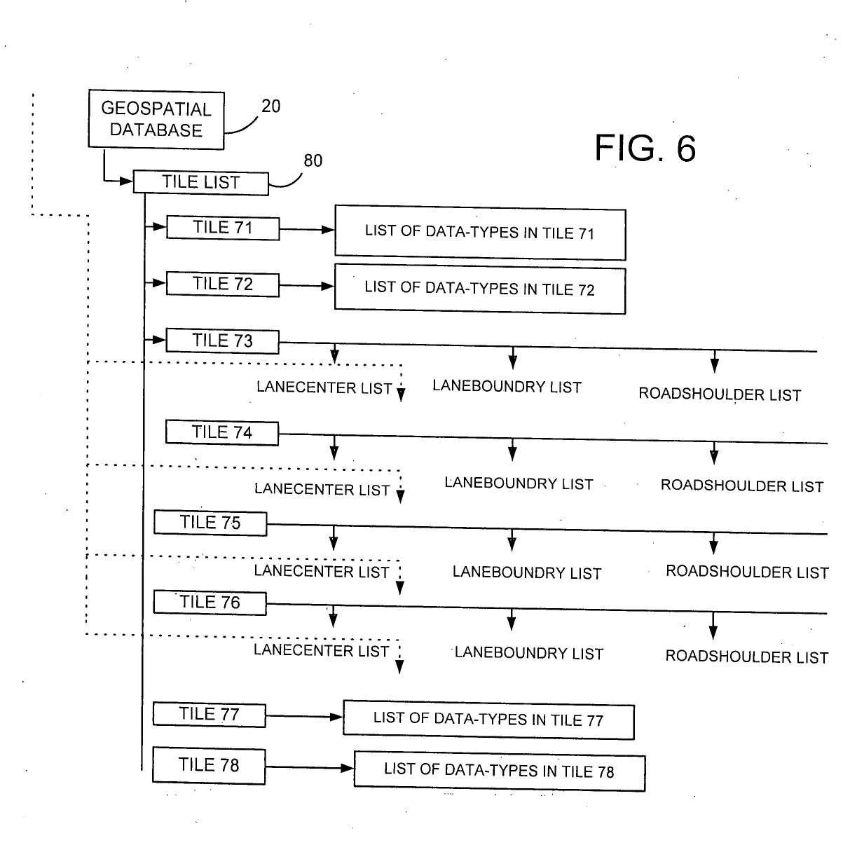

FIG. 4 will now be described in conjunction with FIGS. 5 and 6. FIG. 5 illustrates a first portion of the query processing.

Database manager 22 maintains the database by subdividing it into tiles, or buckets, such as tiles 71-78 illustrated in FIG. 5. Of course, database 20 will illustratively be divided into a very large number of tiles and only 8 are shown in FIG. 5 for the sake of simplicity. The tiles are listed in a tile list, such as list 80 shown in FIG. 6. Tile list 80 includes a list of the tiles, and their associated spatial boundaries (the spatial or geographic area which they cover).

Within each of the tiles are separate homogeneous object lists. That is, each list within a tile only contains objects of the same object type. This is shown in FIG. 6, for example, as the LaneCenter list, the LaneBoundary list, and the RoadShoulder list for tile 3. In other words, the LaneCenter list lists all of the LaneCenter objects contained in, or intersecting, the geographic area defined by tile 3. The LaneBoundary list lists all of the LaneBoundary objects found in, or intersecting, the geographic area defined by tile 3 and so on.

When query processor 24 retrieves a query from the query queue, it examines the query polygon 81 defined by the particular subsystem 14 that generated the query. Recall that the query polygon 81 is a polygon of interest to the subsystem. Query processor 24 first examines tile list 80 to determine which of the tiles 71-78 the query polygon 81 intersects. This is indicated by block 82 in FIG. 4.

The method of determining whether the query polygon 81 intersects any of the tiles 71-78 is diagrammatically illustrated in FIG. 5 as well. FIG. 5 shows that query polygon 81 intersects tiles 73, 74, 75 and 76.

Once the intersecting tiles have been identified, query processor 24 then queries the intersecting tiles 73-76 by identifying object lists in the intersecting tiles that contain object types specified by the object list in the query 16 generated by the subsystem 14. This is indicated by block 84 in FIG. 4. In one example, query processor 24 identifies the tiles that contain desired objects by simply doing a string compare between the object list in the query 16 and the objects in the intersecting tiles.

Once query processor 24 has identified objects within an intersecting tile that meet the attributes specified in the query 16, query processor 24 then determines whether any of those specific objects intersect with the query polygon 81. This is indicated by block 86 in FIG. 4.

Having now identified particular objects which not only intersect the query polygon 81, but which are also desired object types (desired by the subsystem 14 that generated the query 16) query processor 24 tabulates the results and passes them back to database manager 22. Database manager 22, in turn, passes query results 18 back to the subsystem 14 for processing by that subsystem. This is indicated by block 86 in FIG. 4.

It can be seen that the present invention only needs to do a small number of initial intersection calculations in determining which tiles intersect the query polygon. This yields lists of objects in the same general vicinity as the query polygon. Then, by doing a simple string compare against the object lists, the present system identifies objects of interest in the same general vicinity as the query polygon before doing intersection computations on any of the individual objects. Thus, the intersection computations are only performed for objects of interest that have already been identified as being close to the query polygon. This drastically reduces the number of intersection computations which are required. This greatly enhances the processing speed used in identifying intersecting objects having desired object types.

In one illustrative embodiment, the operation of the database manager 22 and query processor 24 was programmed in the C computer language with function calls simplified by using only pointers as illustrated with respect to FIG. 3, such that no large structures or arrays are passed through the functions. The specific query processing routines are known and are taught, for example, in Computational Geometry In C, written by Joseph O'Rourke, Cambridge University Press, Second Edition, September 1998. The main processing routines are point-in-polygon and line-line intersection routines. In the routines, a line-string intersects a polygon if any of the line-string's points are contained within the polygon, or if any segment of the line-string, defined by two consecutive points, intersects any edge of the polygon. The polygon-polygon intersection is the same as a line-string-polygon intersection. An arc-segment is treated as if it were a line-string. Even though an arc-segment can be described by its radius, start and end points, within a database it is represented as having interior points for query processing.

In order to further enhance the speed of the query process, no clipping or merging is performed on the results. Objects that intersect the query polygon are returned whole. There is no attempt to return only the part of the object that is within the query polygon, or merge together similar objects.

The size of the tiles within geospatial database 20 can vary with application. In general, smaller tile sizes produce a larger number of objects, but with a smaller average number of objects per tile. Also, larger tiles have a smaller number of objects but a larger average number of objects per tile. It has been observed that, as tile size increases, query times to the database also increase. This increase in query time is due to the fact that larger tiles contain more objects and during query processing, all relevant objects must be checked against the query polygon. It is also observed that the query time begins to increase again as the tile size is reduced below approximately 1000 square meters. The increase in query time as the tile size decreases is from the overhead of handling more tiles. As the tile size decreases, the number of tiles that intersect the query polygon increases. It was observed that, for the head up display and target filter subsystems, the minimum mean query time was observed for tiles being 1000 square meters. For the virtual rumble strip, the database having tiles of 2000 square meters performed best. However, it is believed that optimum tile size in the database will be between approximately 500-6000 square meters, and may illustratively be between 500-4000 square meters and may still further be between 500-2000 square meters and may be approximately 1000 square meters to obtain a best overall performance.

It has also been observed that increasing the size of a query polygon does not significantly affect the time to process that query. Thus, as query processing needs to be reduced to free up processing time, the query polygon may be increased in size with little effect in query processing time.

It should also be noted that tile size in the present invention can be varied based on information density. In other words, in rural areas, there are very few items contained in the geospatial database, other than road boundaries and center lines. However, in urban areas, there may be a wide variety of center islands, curbs, and other objects that must be contained in the geospatial database at a greater density. In that case, the database can be tiled based on content (e.g., based on the amount of objects on the road).

It should also be noted that a known algorithm (the Douglas-Peucker Algorithm set out in D. Douglas and P. Pucker, Algorithms for the Reduction of the Number of Points Required to Represent a Digitized Line or Its Character, the Canadian Cartographer, 10(2):112-122, December 1973) was used to remove unwanted vertices from a list of points within a given tolerance.

Further, the tiles or buckets described herein are but one exemplary way to aggregate data in space. For example, a quadtree system can be used as well, which recursively subdivides space. Other known techniques can also be used.

The present database management system can return query results using real time processing. Thus, the present invention can provide an output (query results) to subsystems for collision detection and for lane-level guidance in real time. By “real time” it is meant that the query must be returned in sufficient time to adequately operate the host vehicle on which it is contained. In one illustrative embodiment, such as an automobile, real time requires query processing (i.e., returning the query results from the time the query was received) in less than 0.1 seconds (100 milliseconds) and 50 ms may be even more desirable. The present invention has been observed to return query results, at a worst case time of approximately 12 milliseconds.

It can thus be seen that present invention differs greatly from traditionally designed and commonly used digital maps. The present invention includes objects located within a geospatial database with a resolution that is at a lane level, or even sub-lane level rather than simply at a road level. As understood by those skilled in the art, the road representing nodes utilized by traditional navigational systems only allow for navigation along the longitudinal direction of the road and provide general directional guidance. On the other hand, the “lane level” or “sub-lane level” resolution of the data elements of the geospatial database of the present invention allow for the navigation and collision avoidance within a lane of a road. For example, the data elements of the geospatial database accurately identify road features of a road, such as boundaries of a lane of the road, which are displaced from each other in a widthwise direction that is transverse (i.e., across the lengthwise direction) to the road. Thus, for example, the subsystems of the present invention can be used to determine the lane or portion of a lane, in which a vehicle is located based upon a comparison of the actual location of the vehicle and the location of the lanes of the road as defined by the data elements or objects of the geospatial database.

The data contained in the geospatial database is also accurate to within submeter distances, such as to within approximately plus/minus 10 cm and may be within a range of approximately ±2-10 cm. All this data can be processed in real time.

A number of additional applications for the present invention will now be described. In should be noted that besides the warning systems described below, the geospatial data base can be used to implement automated collision avoidance systems as documented in the following references: M. Hennessey, C. Shankwitz and M. Donath “Sensor Based ‘Virtual Bumpers’ for Collision Avoidance: Configuration Issues”, in Collision Avoidance and Automated Traffic Management Sensors, A. C. Chachich and M. J. de Vries, editors, Vol. 2592, pp. 48-59, Philadelphia, Pa., SPIE Proceedings, October, 1995. C. Shankwitz, M. Donath, V. Morellas and D. Johnson “Sensing and Control to Enhance the Safety of Heavy Vehicles”, Proceedings of the Second World Congress on Intelligent Transport Systems, pp. 1051-1056 (Volume 3), Yokohama, Japan, ITS America, November 1995. W. Schiller, Y. Du, D. Krantz, C. Shankwitz and M. Donath “Vehicle Guidance Architecture for Combined Lane Tracking and Obstacle Avoidance”, Chapter 7 in Artificial Intelligence and Mobile Robots: Case Studies of Successful Robot Systems”. Edited by D. Kortenkamp, R. Peter Bonasso and Robin Murphy, pp. 159-192, AAAI Press/The MIT Press, Cambridge, Mass., 1998. W. Schiller, V. Morellas and M. Donath “Collision Avoidance for Highway Vehicles Using the Virtual Bumper Controller”, Proceedings of the 1998 Intelligent Vehicles Conference, Stuttgart, Germany, October, 1998. A. Gorjestani and M. Donath “Longitudinal Virtual Bumper Collision Avoidance System Implemented on a Truck,” Proceedings of the 6^{th} ITS World Congress, Toronto, Canada, November, 1999. A. Gorjestani, C. Shankwitz and M. Donath, “Impedance Control for Truck Collision Avoidance,” Proceedings of the American Control Conference, Chicago, Ill., June 2000.

As mentioned above, the geospatial database of the present invention is used in combination with a subsystem 14 to assist a driver of a vehicle. For example, the geospatial database that contains roadway features can be used with a vehicle location device to determine the vehicle's position with respect to the road. The data elements of the geospatial database preferably define the location of lane boundaries of the road, which are displaced from each other in a widthwise direction that is transverse to the road are used to determine a location of the vehicle within lane boundaries of the road. Based on the vehicle's location within the lane, one can assist the driver in maintaining the vehicle within the lane during impaired or low visibility conditions, generate warnings that alert the driver of a possible road/lane departure, and provide other assistance to the driver.

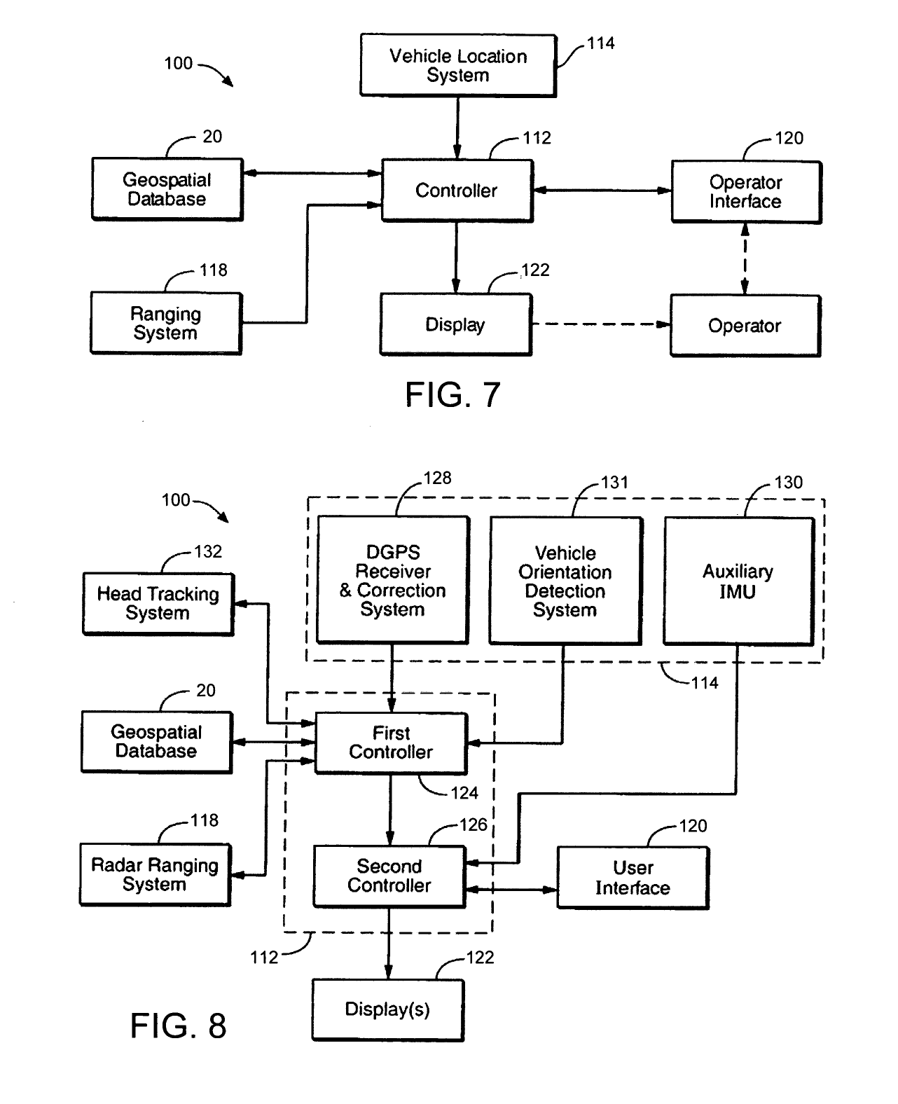

A detailed description of one such subsystem is described in U.S. patent application Ser. No. 09/618,613, filed Jul. 18, 2000, and entitled MOBILITY ASSIST DEVICE, some of the content of which is discussed below with respect to FIGS. 7-9I. FIG. 7 is a simplified block diagram of embodiments of a driver assist subsystem or device 100 that utilizes the geospatial database 20 or management system 10. Driver assist device 100 can include a subsystem controller 112, vehicle location system 114, ranging system 118, operator interface 120 and display 122.

In one embodiment, controller 112 is a microprocessor, microcontroller, digital computer, or other similar control device having associated memory and timing circuitry. It should be understood that the memory can be integrated with controller 112, or be located separately therefrom. The memory, of course, may include random access memory, read only memory, magnetic or optical disc drives, tape memory, or any other suitable computer readable medium.

Operator interface 120 is illustratively a keyboard, a touch-sensitive screen, a point and click user input device (e.g. a mouse), a keypad, a voice activated interface, joystick, or any other type of user interface suitable for receiving user commands, and providing those commands to controller 112, as well as providing a user viewable indication of operating conditions from controller 112 to the user. The operator interface may also include, for example, the steering wheel and the throttle and brake pedals suitably instrumented to detect the operator's desired control inputs of heading angle and speed. Operator interface 120 may also include, for example, a LCD screen, LEDs, a plasma display, a CRT, audible noise generators, or any other suitable operator interface display or speaker unit.

Vehicle location system 114 determines and provides a vehicle location signal, indicative of the vehicle location in which driver assist device 100 is mounted, to controller 112. Thus, vehicle location system 114 can include a global positioning system receiver (GPS receiver) such as a differential GPS receiver, an earth reference position measuring system, a dead reckoning system (such as odometery and an electronic compass), an inertial measurement unit (such as accelerometers, inclinometers, or rate gyroscopes), etc. In any case, vehicle location system 114 periodically provides a location signal to controller 112 which indicates the location of the vehicle on the surface of the earth.

As explained above, geospatial database 20 contains a digital map which digitally locates road boundaries, lane boundaries, possibly some landmarks (such as road signs, water towers, or other landmarks) and any other desired items (such as road barriers, bridges etc. . . . ) and describes a precise location and attributes of those items on the surface of the earth.

It should be noted that there are many possible coordinate systems that can be used to express a location on the surface of the earth, but the most common coordinate frames include longitudinal and latitudinal angle, state coordinate frame, and county coordinate frame.

Because Earth is approximately spherical in shape, it is convenient to determine a location on the surface of the earth if the location values are expressed in terms of an angle from a reference point. Longitude and latitude are the most commonly used angles to express a location on the earth's surface or in orbits around the earth. Latitude is a measurement on a globe of location north or south of the equator, and longitude is a measurement of the location east or west of the prime meridian at Greenwich, the specifically designated imaginary north-south line that passes through both geographic poles of the earth and Greenwich, England. The combinations of meridians of longitude and parallels of latitude establishes a framework or grid by means of which exact positions can be determined in reference to the prime meridian and the equator. Many of the currently available GPS systems provide latitude and longitude values as location data.

Even though the actual landscape on Earth is a curved surface, it is recognized that land is utilized as if it is a flat surface. A Cartesian coordinate system whose axes are defined as three perpendicular vectors is usually used. Each state has its own standard coordinate system to locate points within their state boundaries. All construction and measurements are done using distance dimensions (such as meters or feet). Therefore, a curved surface on the earth needs to be converted into a flat surface and this conversion is referred to as a projection. There are many projection methods used as standards for various local areas on the earth's surface. Every projection involves some degree of distortion due to the fact that a surface of a sphere is constrained to be mapped onto a plane.

One standard projection method is the Lambert Conformal Conic Projection Method. This projection method is extensively used in a ellipsoidal form for large scale mapping of regions of predominantly east-west extent, including topographic, quadrangles for many of the U.S. state plane coordinate system zones, maps in the International Map of the World series and the U.S. State Base maps. The method uses well known, and publicly available, conversion equations to calculate state coordinate values from GPS receiver longitude and latitude angle data.

The data elements stored in the geospatial database 20 define a digital map including a series of numeric location data of, for example, the center line and lane boundaries of a road on which system 100 is to be used, as well as construction data which is given by a number of shape parameters including, starting and ending points of straight paths, the center of circular sections, and starting and ending angles of circular sections. While the present system is described herein in terms of starting and ending points of circular sections it could be described in terms of starting and ending points and any curvature between those points. For example, a straight path can be characterized as a section of zero curvature. Each of these items is indicated by a parameter marker, which indicates the type of parameter it is, and has associated location data giving the precise geographic location of that point on the map.

In one embodiment, the data elements correspond to road points, separated by 10 meter intervals, which define the road of the digital map. In accordance with one embodiment of the invention, the data elements identify the location of only the centerline of the road, and the lane boundaries displaced therefrom in a widthwise direction that is transverse to the road are calculated from that centerline location. In another embodiment, both the center line and lane boundaries are mapped. In other words, the geospatial database 20 includes data elements that represent road features (i.e., lane boundaries) that are displaced from each other in a widthwise direction that is transverse to the road. Additionally, geospatial database 20 can also contain data elements that include the exact location data indicative of the exact geographical location of street signs and other desirable landmarks.

Database 20 can be obtained by manual mapping operations or by a number of automated methods such as, for example, placing a GPS receiver on the lane stripe paint spraying nozzle or tape laying mandrel to continuously obtain locations of lane boundaries.

Ranging system 118 is configured to detect targets in the vicinity of the vehicle in which subsystem 100 is implemented, and also to detect a location (such as range, range rate and azimuth angle) of the detected targets, relative to the vehicle. Targets are illustratively objects which must be monitored because they may collide with the mobile body either due to motion of the body or of the object. In one illustrative embodiment, ranging system 118 is a radar system commercially available from Eaton Vorad. However, ranging system 118 can also include a passive or active infrared system (which could also provide the amount of heat emitted from the target) or laser based ranging system, or a directional ultrasonic system, or other similar systems. Another embodiment of system 118 is an infrared sensor calibrated to obtain a scaling factor for range, range rate and azimuth which is used for transformation to an eye coordinate system.

Display 122 includes a projection unit and one or more combiners which are described in greater detail later in the specification. Briefly, the projection unit receives a video signal from controller 112 and projects video images onto one or more combiners. The projection unit illustratively includes a liquid crystal display (LCD) matrix and a high-intensity light source similar to a conventional video projector, except that it is small so that it fits near the driver's seat space. The combiner is a partially-reflective, partially transmissive beam splitter formed of optical glass or polymer for reflecting the projected light from the projection unit back to the driver. In one embodiment, the combiner is positioned such that the driver looks through the combiner, when looking through the forward-looking visual field, so that the driver can see both the actual outside road scene, as well as the computer generated images projected onto the combiner. In one illustrative embodiment, the computer-generated images substantially overlay the actual images.

It should also be noted, however, that combiners or other similar devices can be placed about the driver to cover substantially all fields of view or be implemented in the glass of the windshield and windows. This can illustratively be implemented using a plurality of projectors or a single projector with appropriate optics to scan the projected image across the appropriate fields of view.

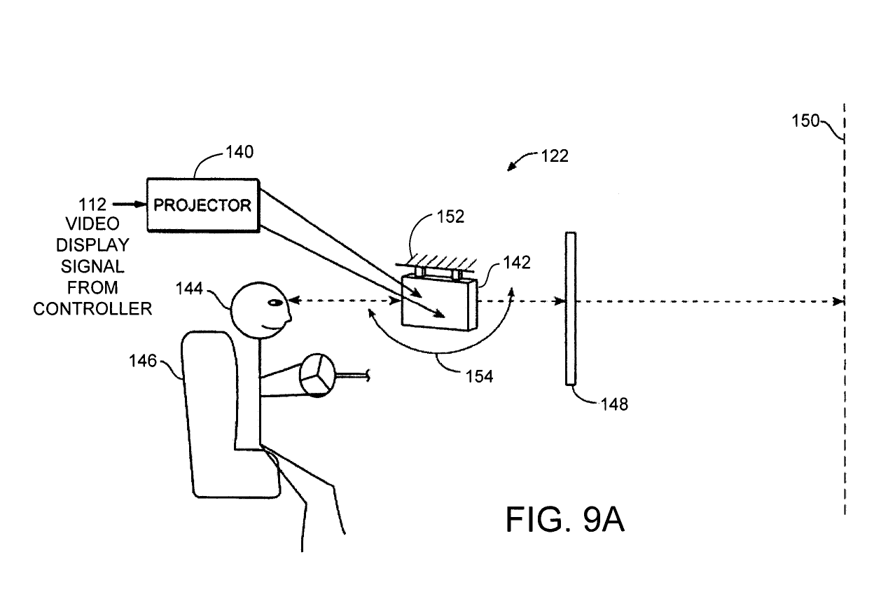

Before discussing the operation of system 10 in greater detail, it is worth pointing out that system 100 can also, in one illustrative embodiment, be varied, as desired. For example, FIG. 8 illustrates that controller 112 may actually be formed of first controller 124 and second controller 126 (or any number of controllers with processing distributed among them, as desired). In that embodiment, first controller 124 performs the primary data processing functions with respect to sensory data acquisition, and also performs database queries in the geospatial database 20 or geospatial database management system 10. This entails obtaining velocity and heading information from GPS receiver and correction system 128. First controller 124 also performs processing of the target signal from radar ranging system 118.

FIG. 8 also illustrates that vehicle location system 114 may illustratively include a differential GPS receiver and correction system 128 as well as an auxiliary inertial measurement unit (IMU) 130 (although other approaches would also work). Second controller 126 processes signals from auxiliary IMU 130, where necessary, and handles graphics computations for providing the appropriate video signal to display 122.

In a specific illustrative embodiment, differential GPS receiver and correcting system 128 is illustratively a Novatel RT-20 differential GPS (DGPS) system with a 20-centimeter accuracy, while operating at a 5 Hz sampling rate or Trimble MS 750 with 2 cm accuracy operating at 10 Hz sampling rate.

FIG. 8 also illustrates that system 100 can include optional vehicle orientation detection system 131 and head tracking system 132. Vehicle orientation detection system 131 detects the orientation (such as roll and pitch) of the vehicle in which system 10 is implemented. The roll angle refers to the rotational orientation of the vehicle about its longitudinal axis (which is parallel to its direction of travel). The roll angle can change, for example, if the vehicle is driving over a banked road, or on uneven terrain. The pitch angle is the angle that the vehicle makes in a vertical plane along the longitudinal direction. The pitch angle becomes significant if the vehicle is climbing up or descending down a hill. Taking into account the pitch and roll angles can make the projected image more accurate, and more closely conform to the actual image seen by the driver.

Optional head tracking system 132 can be provided to accommodate for movements in the driver's head or eye position relative to the vehicle. Of course, in one illustrative embodiment, the actual head and eye position of the driver is not monitored. Instead, the dimensions of the cab or operator compartment of the vehicle in which system 100 is implemented are taken and used, along with ergonomic data, such as the height and eye position of an operator, given the dimension of the operator compartment, and the image is projected on display 122 such that the displayed images will substantially overlie the actual images for an average operator. Specific measurements can be taken for any given operator as well, such that such a system can more closely conform to any given operator.

Alternatively, optional head tracking system 132 is provided. Head tracking system 132 tracks the position of the operator's head, and eyes, in real time.

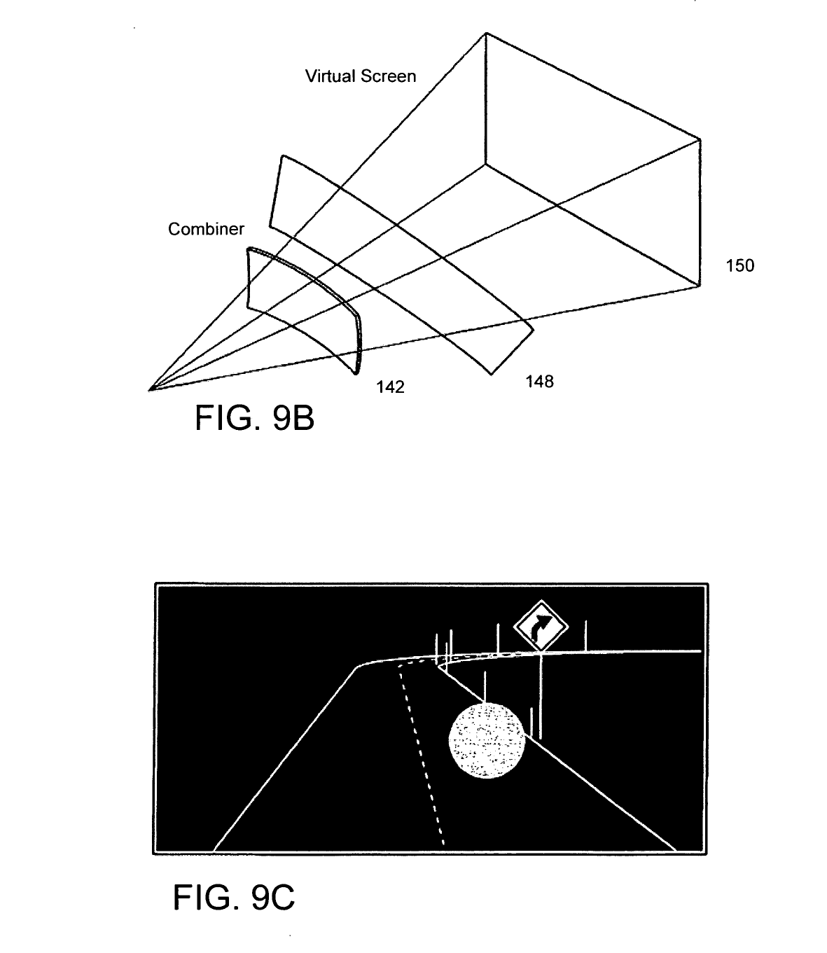

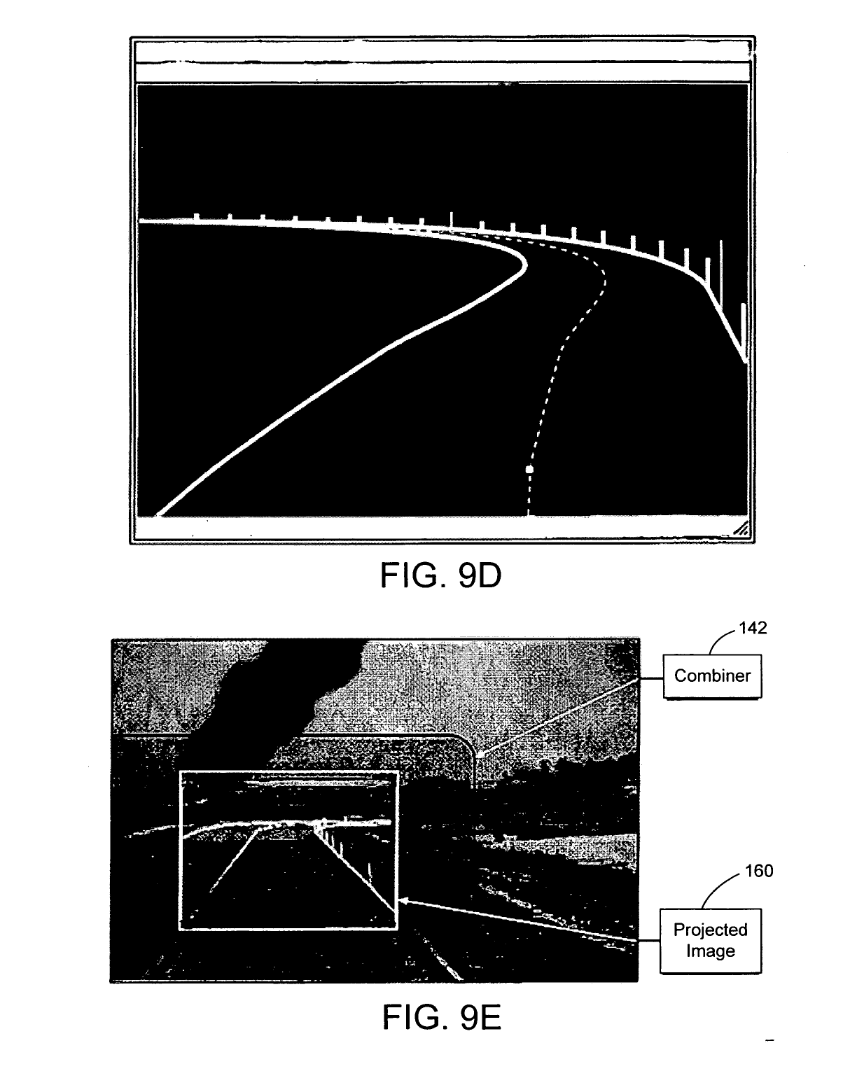

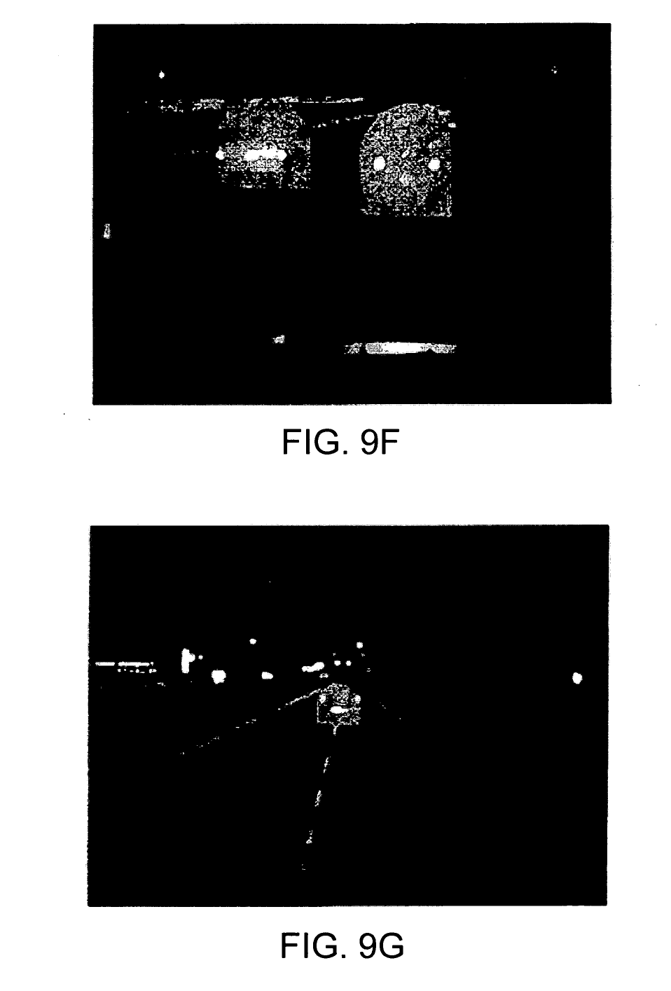

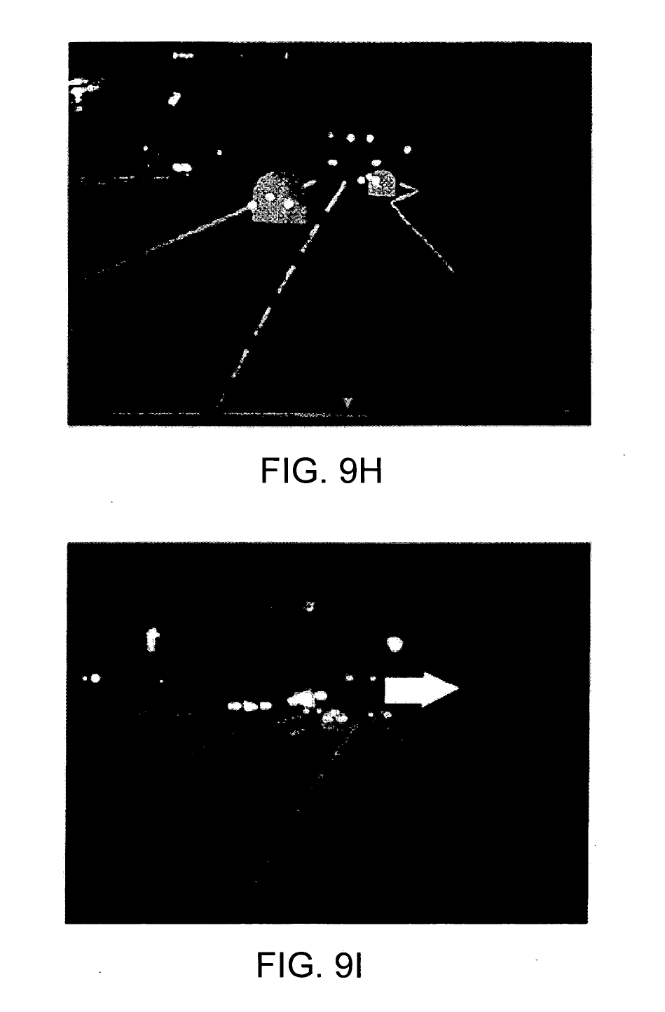

FIGS. 9A-9E better illustrate the display of information on display 122. FIG. 9A illustrates that display 122 can include projector 140, and combiner 142. FIG. 9A also illustrates an operator 144 sitting in an operator compartment which includes seat 146 and which is partially defined by windshield 148.

Projector 140 receives the video display signal from controller 112 and projects road data identified by the data elements of geospatial database 20 onto combiner 142. Combiner 142 is partially reflective and partially transmissive. Therefore, the operator looks forward through combiner 142 and windshield 148 to a virtual focal plane 150. The road data (such as lane boundaries) are projected from projector 140 in proper perspective onto combiner 142 such that the lane boundaries appear to substantially overlie (i.e., conform) those which the operator actually sees, in the correct perspective. In this way, when the operator's view of the actual lane boundaries becomes obstructed, the operator can safely maintain lane keeping because the operator can navigate by the projected lane boundaries.

FIG. 9A also illustrates that combiner 142, in one illustrative embodiment, is hinged to an upper surface or side surface or other structural part 152, of the operator compartment. Therefore, combiner 142 can be pivoted along an arc generally indicated by arrow 154, up and out of the view of the operator, on days when no driver assistance is needed, and down to the position shown in FIG. 9A, when the operator desires to look through combiner 142.

FIG. 9B better illustrates combiner 142, window 148 and virtual screen or focal plane 150. Combiner 142, while being partially reflective, is essentially a transparent, optically correct, coated glass or polymer lens. Light reaching the eyes of operator 144 is a combination of light passing through the lens and light reflected off of the lens from the projector. With an unobstructed forward-looking visual field, the driver actually sees two images accurately superimposed together. The image passing through the combiner 142 comes from the actual forward-looking field of view, while the reflected image is generated by the graphics processor portion of controller 112. The optical characteristics of combiner 142 allow the combination of elements to generate the virtual screen, or virtual focal plane 150, which is illustratively projected to appear approximately 30-80 feet ahead of combiner 142. This feature results in a virtual focus in front of the vehicle, and ensures that the driver's eyes are not required to focus back and forth between the real image and the virtual image, thus reducing eyestrain and fatigue.

In one illustrative embodiment, combiner 142 is formed such that the visual image size spans approximately 30° along a horizontal axis and 15° along a vertical axis with the projector located approximately 18 inches from the combiner.

Another embodiment is a helmet supported visor (or eyeglass device) on which images are projected, through which the driver can still see. Such displays might include technologies such as those available from Kaiser Electro-Optics, Inc. of Carlsbad, Calif., The MicroOptical Corporation of Westwood, Mass., Universal Display Corporation of Ewing, N.J., Microvision, Inc. of Bothell, Wash. and IODisplay System LLC of Menlo Park, Calif.

FIGS. 9C and 9D are illustrative displays from projector 140 which are projected onto combiner 142. In FIGS. 9C and 9D, the left most line is the left side road boundary. The dotted line corresponds to the centerline of a two-way road, while the right most curved line, with vertical poles, corresponds to the right-hand side road boundary. The gray circle near the center of the image shown in FIG. 9C corresponds to a target detected and located by ranging system 118 described in greater detail later in the application. Of course, the gray shape need not be a circle but could be any icon or shape and could be transparent, opaque or translucent.

The screens illustrated in FIGS. 9C and 9D can illustratively be projected in the forward-looking visual field of the driver by projecting them onto combiner 142 with the correct scale so that objects (including the painted line stripes and road boundaries) in the screen are superimposed on the actual objects in the outer scene observed by the driver. The black area on the screens illustrated in FIGS. 9C and 9D appear transparent on combiner 142 under typical operating conditions. Only the brightly colored lines appear on the virtual image that is projected onto combiner 142. While the thickness and colors of the road boundaries illustrated in FIGS. 9C and 9D can be varied, as desired, they are illustratively white lines that are approximately 1-5 pixels thick while the center line is also white and is approximately 1-5 pixels thick as well.

FIG. 9E illustrates a virtual image projected onto an actual image as seen through combiner 142 by the driver. The outline of combiner 142 can be seen in the illustration of FIG. 9E and the area 160 which includes the projected image has been outlined in FIG. 9E for the sake of clarity, although no such outline actually appears on the display. It can be seen that the display generated is a conformal, augmented display which is highly useful in low-visibility situations. Geographic landmarks are projected onto combiner 42 and are aligned with the view out of the windshield. Fixed roadside signs (i.e., traditional speed limit signs, exit information signs, etc.) can be projected onto the display, and if desired virtually aligned with actual road signs found in the geospatial landscape. Data supporting fixed signage and other fixed items projected onto the display are retrieved from geospatial database 20.

FIGS. 9F-9H are pictorial illustrations of actual displays. FIG. 9F illustrates two vehicles in close proximity to the vehicle on which system 100 is deployed. It can be seen that the two vehicles have been detected by ranging system 118 and have icons projected thereover. FIG. 9G illustrates a vehicle more distant than those in FIG. 9F. FIG. 9G also shows line boundaries which are projected over the actual boundaries. FIG. 9H shows even more distant vehicles and also illustrates objects around an intersection. For example, right turn lane markers are shown displayed over the actual lane boundaries.

The presence and condition of variable road signs (such as stoplights, caution lights, railroad crossing warnings, etc.) can also be incorporated into the display. In that instance, controller or processor 112 determines, based on access to the geospatial database, that a variable sign is within the normal viewing distance of the vehicle. At the same time, a radio frequency (RF) receiver (for instance) which is mounted on the vehicle decodes the signal being broadcast from the variable sign, and provides that information to processor 112. Processor 112 then proceeds to project the variable sign information to the driver on the projector. Of course, this can take any desirable form. For instance, a stop light with a currently red light can be projected, such that it overlies the actual stoplight and such that the red light is highly visible to the driver. Other suitable information and display items can be implemented as well.

For instance, text of signs or road markers can be enlarged to assist drivers with poor night vision. Items outside the driver's field of view can be displayed (e.g., at the top or sides of the display) to give the driver information about objects out of view. Such items can be fixed or transitionary objects or in the nature of advertising such as goods or services available in the vicinity of the vehicle. Such information can be included in the geospatial database and selectively retrieved based on vehicle position.

Directional signs can also be incorporated into the display to guide the driver to a destination (such as a rest area or hotel), as shown in FIG. 9I. It can be seen that the directional arrows are superimposed directly over the lane.

It should be noted that geospatial database 20 can be stored locally on the vehicle or queried remotely. Also, database 20 can be periodically updated (either remotely or directly) with a wide variety of information such as detour or road construction information or any other desired information.

The presence and location of transitory obstacles (also referred to herein as unexpected targets) such as stalled cars, moving cars, pedestrians, etc. are also illustratively projected onto combiner 142 with proper perspective such that they substantially overlie the actual obstacles. Transitory obstacle information indicative of such transitory targets or obstacles is derived from ranging system 118. Transitory obstacles are distinguished from conventional roadside obstacles (such as road signs, etc.) by processor 112. Processor 112 senses an obstacle from the signal provided by ranging system 118. Processor 112, then during its query of geospatial database 20, determines whether the target indicated by ranging system 118 actually corresponds to a conventional, expected roadside obstacle which has been mapped into database 20. If not, it is construed as a transitory obstacle, and projected, as a predetermined geometric shape, or bit map, or other icon, in its proper perspective, on combiner 142. The transitory targets basically represent items which are not in a fixed location during normal operating conditions on the roadway.

Of course, other objects can be displayed as well. Such objects can include water towers, trees, bridges, road dividers, other landmarks, etc. . . . . Such indicators can also be warnings or alarms such as not to turn the wrong way on a one-way road or an off ramp, that the vehicle is approaching an intersection or work zone at too high a high rate of speed. Further, where the combiner is equipped with an LCD film or embedded layer, it can perform other tasks as well. Such tasks can include the display of blocking templates which block out or reduce glare from the sun or headlights from other cars. The location of the sun can be computed from the time, and its position relative to the driver can also be computed (the same is true for cars). Therefore, an icon can simply be displayed to block the undesired glare. Similarly, the displays can be integrated with other operator perceptible features, such as a haptic feedback, sound, seat or steering wheel vibration, etc.

As mentioned above, warnings to the driver of the vehicle can be provided based upon the location of the vehicle relative to the locations of road features or objects defined by the data elements of the geospatial database. The criteria for issuing a warning depends on the application. For example, a lane departure warning can be issued if the vehicle leaves the boundaries of the lane as determined by the lane boundaries in the geospatial database. An alternative criteria can be to only provide a warning if the vehicle is in danger of leaving the road or crossing into an opposing lane of traffic. Other roadside features such as guard rails can be embedded in the database and warnings can be given based on the proximity to these roadside features.

The warning can take many forms. Some examples can include visual (which has already been discussed in the “Mobility Assist Device” patent application, incorporated above by reference, and will not be discussed here), or audio, tactile, and haptic based warnings.

An audio warning can be given if the vehicle violates the criteria established in a position warning policy. Such a policy describes when and how warnings are communicated to the driver. The warning policy, or algorithm, is one that can be developed, for example, by human factors' scientists. The warning may be as simple as a tone or as complex as synthesized speech. Stereo audio can be used to more intuitively communicate a position-centered warning to the driver. For example, a lane departure to the right of the lane boundary in the road database can induce a warning generated in the right side speaker(s) in the vehicle. Similarly, a departure to the left can generate an audible warning from the left side speaker(s). The volume and type of warning can also be manipulated based on the severity of the departure or the severity of the consequences of the departure.

A tactile warning can be given if the vehicle violates the criteria established in the position warning policy. Vibration through the seat is one such example of a tactile warning. A departure to the left can invoke a left side warning and the left side of the seat can be vibrated to quickly communicate the departure location to the driver. Similarly, a departure to the right can invoke a right side vibration of the seat. Again, the amplitude and frequency of the seat vibration can be dynamically altered based on the nature of the departure.

Haptic feedback is a system that warns the driver through the hands or feet (or other human-machine interface point) that the vehicle is moving into a position on the road which is not permissible or “dangerous”. Moving out of one's lane can cause the steering wheel to provide resistive torque, not unlike trying to steer over a bump. That resistive torque disappears after the vehicle has moved fully into the adjacent lane, if that adjacent lane is safe (i.e. no other vehicle is present and the lane allows vehicles to pass, or the lane is legitimately marked for driving in the same direction). More information on haptic feedback is provided below.

An object detection sensor mounted on the vehicle and a safety policy can be used to generate warnings to the driver. An array of object detection sensors can also be employed such that the coverage area surrounds the vehicle. In such a system, a warning can be issued when vehicles encroach upon a programmable ‘virtual boundary’ surrounding the host vehicle (the one carrying the driver). The virtual boundary can be dynamic and related to the road geometry in the map database. The warning can be proportional to the level and location of the encroachment by the other vehicles or objects into the host vehicle's virtual boundary. For example, it may change its shape with road curvature or as the vehicle enters an intersection. The warnings can take several forms and can be combined with the position warnings discussed above. For example, a departure from the current driving lane may be tolerated if the adjacent lane is a valid lane and no other vehicles are detected in the area that the vehicle performing the lane departure is attempting to occupy. However, if the object detection device detects a vehicle in the adjacent lane according to the map database, a warning can be issued. A different warning or different intensity warning can be given based on the location of surrounding vehicles in the road map database.

An audio warning can be given to the driver if another vehicle penetrates the virtual boundary of the host vehicle. With stereo audio, the warning can be given on the side that the incursion takes place. For example, a target vehicle that encroaches on the left side virtual boundary can impart a warning to the left side speaker(s). Similarly, a target vehicle that encroaches on the right side virtual boundary can produce a warning to the right side speaker(s). If more channels of audio are present, a warning can be given to the speaker closest to the incursion. The warning sound can vary in frequency and amplitude depending on the severity of the incursion. A virtual sound source can be located anywhere within 360 degrees of the driver. A warning message can also be different based upon different situations, local road characteristics and the severity of the incursion.

A tactile warning can be given to the driver if another vehicle penetrates the virtual boundary of the host vehicle. A seat vibration may be used to alert the driver to a target vehicle within the virtual boundary of the host vehicle. For example, a vehicle penetrating the right side virtual boundary can produce a vibration in the right side of the seat. Similarly, an incursion into the left side of the virtual boundary can produce a vibration in the left side of the seat. The frequency and amplitude of the warning can be related to the severity of the encroachment.

A haptic warning can be given to the driver if another vehicle encroaches into the virtual boundary of the host vehicle. The feedback can be through the steering wheel, accelerator pedal and/or brake pedal. For example, an incursion into the right side virtual boundary can cause the object warning system to induce a torque to the steering wheel that alerts the driver of the incursion. If the incursion was to take place in front of the vehicle, feedback to the pedals can alert the driver that the headway to the lead vehicle is insufficient. The pedal feedback can be as simple as a pulse, or a more complicated dynamically changing force, related to the target vehicle's position, velocity and acceleration with respect to the host vehicle and the geospatial database. More on haptic interfaces is described below.

A geospatial database can include a high degree of detail related to the layout of the roadway and the surrounding “road furniture”. These details can be used to enhance a driver assistive haptic warning system in several ways. As discussed above, one set of data that can be included in the geospatial database of the present invention is the accurate location of the center of the driving lanes. The distance from the center of the vehicle to the center of the driving lane can be used to trigger various types of warnings.

Visual, auditory, tactile, and haptic feedback that are used to provide warnings about vehicle position or about other objects in front of the vehicle have been discussed above. Different forms of haptic feedback will now be discussed.

When the vehicle position exceeds a certain predetermined distance from the center of the lane, an actuator in the steering system is energized to shake the wheel in a manner that simulates the feeling of driving over a rumble strip in the pavement. This “virtual rumble strip” can be programmed to give the steering wheel a gentle push in the direction required to return to the center of the lane. This “push” can take several forms, one of which is a vibrational pattern having an amplitude and frequency that may shift to the right and left as needed. The distance to the center of the lane can also be used to trigger vibrations in the seat (right or left vibrator) and auditory warnings through the vehicle's sound system.

Such haptic systems can be designed to be used in conjunction with the geospatial database of the present invention in order to take advantage of information included therein. For example, if the constantly active real time queries to the geospatial database show that there is an adequate shoulder along the side of the road, then the haptic system can give a less intense warning regarding a potential lane departure in that direction than if the query showed that there is no shoulder. The feedback through the steering wheel can also be programmed to react differently if the vehicle is moving into a lane of oncoming traffic than if the adjacent lane is part of a multi-lane roadway where all traffic is moving in the same direction as the host vehicle.

In the low visibility conditions in which snowplows typically operate, a geospatial database includes the locations of guardrails, signposts and other roadway hardware. The haptic advisory subsystem can then be used (in addition to or instead of a HUD) to help the snowplow operator avoid contact with them thereby avoiding crashes and expensive repairs in the spring. For all of the these specific warnings, it is necessary to have an accurate, high resolution geospatial database that has much more detail than a typical road network database of the type used for route planning.

Haptic feedback based on information in a geospatial database can be added to the throttle and brake pedals as well as the steering wheel. The throttle pedal can be programmed to push back against the driver's foot when a vehicle is approaching an intersection or some other fixed obstacle during a snowstorm or in heavy fog. In an embodiment in which the database contains the location of stop signs at rural intersections, then the braking system can force the vehicle to stop especially if there is reason to suspect that the driver is in some way impaired.

A haptic system can integrate control of the steering, braking, and throttle so that a driver may not steer into a road or lane that only allows traffic in the opposite direction. This is an important feature that would prevent senile drivers or drivers under the influence, for example, from entering and driving in the wrong direction down a road or lane. Similarly, if the vehicle is already pointing in the wrong direction, the system can provide an accelerator pedal resistance until the vehicle is steered out of that direction.

Another application for a haptic steering interface combined with a geospatial database is to help a transit bus driver stay within the boundaries of a narrow bus rapid transit (BRT) lane or within a narrow tunnel lane. During rush hour traffic in certain cities, buses are allowed to use the shoulder of the road to bypass stopped traffic. Since these shoulders are not designed to carry moving traffic, they are not as wide as a standard traffic lane. It can be quite a challenge to maneuver a bus along one of these lanes since the lanes are only a few inches wider than the bus. This task is particularly difficult in inclement weather if the outside edge of the shoulder is covered with snow so the driver cannot see exactly where the edge is. A geospatial database of the present invention can include the precise location of both sides of the BRT lane and a haptic steering system can use that information to assist the driver with centering the vehicle. One technique to use in this situation is to implement a virtual potential field where the system adds a torque to the steering system that will tend to return the vehicle to the proper centered location in the BRT lane. The steering torque is programmed to make the bus feel like it is being driven in a lane with an inverted crown so that it requires a definite effort to steer the bus “up” and out of its proper location in the center of the lane. The width and slope of this virtual potential field can be changed to suit the conditions dictated by information in the geospatial database. Due to congestion, there is more political pressure to squeeze in an additional lane into a tunnel. This can typically only be done by narrowing the lanes, including one explicitly marked for buses only. The Lincoln Tunnel in New York City is one such example. The haptic feedback developed for a narrow bus only shoulder can also be used for narrow tunnel lanes.

The database of the present invention allows the system to know where all the road features of the roadway are located, in real time. This information can be used to improve the signal-to-noise ratio of range sensors. A vehicle location device (e.g. GPS) provides the host vehicle with information as to its location and heading in a global coordinate system. The road database can be queried to provide all the road features (lanes, road boundaries, signs, traffic islands, etc.) surrounding the host vehicle. Range sensors (such as radar) provide the location of objects surrounding the vehicle in some vehicle based local reference frame. The objects detected by the range sensor can be placed in a global reference frame in their proper location on the road using the location device and the high accuracy database. The range sensor returns can then be filtered based on the user's criteria. For example, objects outside the road (i.e. outside the driveable surface) can be filtered if so desired. Any range sensor return outside the roadway as determined by comparison with the road database can be removed from the detected object pool. The criteria for filtering can be based on any map database road feature. Multiple road features can be employed to determine the filtering criteria. An advanced range sensor filter as described above can drastically reduce unwanted range sensor returns that may produce false warnings to the driver when used with an object warning device (audio, haptic, tactile, visual, etc.).

There has been a significant amount of research into assessing the performance of a driver by monitoring his or her control inputs and lane keeping ability. Various researchers have found a positive correlation between erratic control inputs and fatigue, but there are other reasons for erratic driving than lack of sleep or driver impairment. Lateral offsets may be due to road curvature rather than driver error. The condition of the road can also cause a driver to do what might look like a poor job of lane keeping while he or she might actually be just dodging potholes. A geospatial database according to one embodiment of the present invention can contain reasonably up-to-date information on road conditions to help a performance monitoring system decide whether it is the driver or the road that needs to be ‘rejuvenated’.

If a driver performance monitoring system detects a drowsy or otherwise impaired driver there is the question of what to do with that information. It has been found that simply sounding a warning to the driver is not usually enough. The sleepy driver will sometimes incorporate the warning into a dream, ignore alarms and continue driving in a sleepy stupor. A backup system that will take over for the driver when it determines that the human driver is driving inappropriately (due to driver impairment, intoxication, driving under the influence of various substances, etc.) automatically steers the vehicle until it can safely take the vehicle off the road and park it on a safe spot on the shoulder of the road. Once again a detailed geospatial database of the road is necessary to determine if there is a shoulder at the current location, or up ahead, and whether it is wide enough to park safely.

Inappropriate driver behavior can be determined by several means including steering wheel behavior (angular velocity and displacement characteristics), and lateral and longitudinal vehicle behavior. Information from the geospatial database and from a normative driving pattern stored in a “smart card”-based driver's license, ensures that this determination has very few false positives. The driver's unique normal driving behavior can be captured parametrically on this smart card license that must be inserted into the vehicle's control interface in order to allow the vehicle to start. Once those parameters identifying that driver's “normal” parameters are integrated with local geometrical parameters (based on the local features from the geospatial database), one can determine whether the driver is impaired, and then carry out the tasks programmed to take place when the driver is determined to be driving in an impaired fashion.

The database in accordance with one embodiment of the present invention facilitates the use of a virtual bumper for automated collision avoidance maneuvers. The virtual bumper combines longitudinal and lateral collision avoidance capabilities to control a vehicle under normal and emergency situations. A programmable boundary defines a “personal space” around the “host” vehicle. Incursions by “target” vehicles or other objects into this space are sensed by range sensors mounted on the host vehicle. The geospatial database makes it possible to get reliable range and range derivative values. Otherwise, spurious signals can cause the vehicle to maneuver around falsely sensed targets continuously and therefore make this implementation very difficult.

This virtual deflection of the bumper defined by the boundary generates a virtual “force” on the host which affects its trajectory in a manner that attempts to avoid (or at least mitigate) collisions. The relationship between the virtual bumper deflection and the virtual force that is applied to the host vehicle is computed based on a non-linear relationship which is a function of the range and the derivative of range to the objects in the host vehicle's environment. The road (defined in the geospatial database) also induces a virtual force, which attempts to keep the host within its lane of travel.

The virtual bumper includes three main subsystems. The longitudinal control subsystem incorporates impedance control to adjust the headway to vehicles up ahead and maintains the desired traveling speed when no obstacles are present. The lateral control subsystem is an impedance controller that maintains the host vehicle's position in the lane and performs collision avoidance in the side regions of the vehicle. The final component of the virtual bumper is the lane change subsystem, which determines the safest lane of travel based on the road environment and issues lateral position commands that perform lane changes (or direct the vehicle off the road if needed). Again, the lanes of travel are defined in the geospatial database. Host vehicle velocity and acceleration is measured using a Differential Global Position System (DGPS) and then used in the collision avoidance controllers.

Two virtual force types are defined within the longitudinal controller that are designed to provide a comfortable response for differing degrees of control action. The ‘linear’ and ‘non-linear’ forces are named based on their intended response in the range vs. range rate phase plot. The phase plot is formed by placing the measured range (provided by the range sensors) on the x-axis and the range rate (relative velocity) on the y-axis. This phase plot is useful for designing headway controllers because it graphically presents the spacing relationship between the host and target vehicles.

A linear force is applied to the vehicle when low levels of deceleration are required and tends to force the target vehicle's state (range, range rate) toward a linear trajectory in the range-range rate phase plane moving down to the final desired headway. This headway is calculated from a user selected headway time so that it scales with the host vehicle's velocity. The linear force is determined by the impedance of the virtual bumper. The impedance field's spring coefficient and damping coefficient are determined using pole placement techniques and are tuned in software to provide a second order over-damped response.

A non-linear force is applied to the vehicle when higher deceleration is needed to slow down the host vehicle. In order to achieve comfortable braking, a constant deceleration is used, which forms a parabolic trajectory in the range vs. range rate phase plot. A line of constant deceleration based on experiments performed at low levels of braking, is used to switch between the application of nonlinear and linear forces. Any target state below this switching line and within the personal space boundary will be acted upon by the non-linear forces. Similarly, any target state above this switching line will be acted upon by the linear forces. The non-linear forces tend to adjust the host vehicle's velocity/acceleration so that the target state (measured by the range sensors) forms a parabolic trajectory in this phase plane.

Although the present invention has been described with reference to preferred embodiments, workers skilled in the art will recognize that changes may be made in form and detail without departing from the spirit and scope of the invention.

1. A geospatial database management system accessible by components of a motorized vehicle comprising a geospatial database including data elements identifying locations of a plurality of road features of a tangible road, wherein the road features are displaced from each other in a widthwise direction that is transverse to the road.

2. The system of claim 1, wherein the locations are defined in three dimensional space and have an accuracy of approximately one decimeter or less.

3. The system of claim 1, wherein the road features include road boundaries that are proximate side edges of the road.

4. The system of claim 1, wherein the road features include a road boundary of the road that extends proximate the road in a lengthwise direction.

5. The system of claim 4, wherein the road boundary corresponds to a guard rail positioned proximate a side of the road.

6. The system of claim 1, wherein the road features correspond to lane boundaries of at least one lane of the road that are displaced from each other in the widthwise direction and extend along the road in a lengthwise direction.

7. The system of claim 6, wherein the lane boundaries correspond to line markings on the road.

8. The system of claim 7, wherein the line markings correspond to a group consisting of a centerline and a lane boundary line.

9. The system of claim 1 including a data storage medium supported by the motorized vehicle, wherein the locations are stored on the data storage medium.

10. The system of claim 1, wherein the geospatial database includes attribute data identifying the road features corresponding to the locations.

11. The system of claim 10, wherein the attribute data includes information indicative of how the road feature should be graphically represented on a display.

12. The system of claim 1, wherein the geospatial database includes locations of structures that are adjacent to the road.

13. A geospatial database management system for use with a motorized vehicle, the system comprising:
a geospatial database including data elements identifying locations of a plurality of road features of a tangible road, wherein the road features are displaced from each other in a widthwise direction that is transverse to the road;
a driver assist subsystem component supported on the motor vehicle and configured to assist a driver of the motor vehicle based on the locations of the geospatial database;
a database manager component configured to maintain the locations in the geospatial database and receive database queries from the driver assist subsystem; and
a query processor configured to receive the database queries from the database manager component, query the geospatial database based on the database queries and return query results to the database manager component.

14. The system of claim 13, wherein the locations have an accuracy of approximately one decimeter or less.

15. The system of claim 13, wherein the road features include road boundaries at approximate side edges of the road.

16. The system of claim 13, wherein the road features include a road boundary of the road that extends proximate the road in a lengthwise direction.

17. The system of claim 16, wherein the road boundary corresponds to a guard rail positioned proximate a side of the road.

18. The system of claim 13, wherein the road features include lane boundaries of at least one lane of the road that are displaced from each other in the widthwise direction and extend along the road in a lengthwise direction.

19. The system of claim 18, wherein the lane boundaries correspond to line markings on the road.

20. The system of claim 19, wherein the line markings correspond to a group consisting of a centerline and a lane boundary line.

21. The system of claim 13 including a data storage medium supported by the motorized vehicle, wherein the locations are stored on the data storage medium.

22. The system of claim 13, wherein the geospatial database includes attribute data identifying the road features corresponding to the locations.

23. The system of claim 22, wherein the attribute data includes information indicative of how the road feature should be graphically represented on a display.

24. The system of claim 13, wherein the geospatial database includes locations of structures that are adjacent to the road.

25. The system of claim 13, wherein the driver assist subsystem generates haptic feedback to the driver of the vehicle.

26. The system of claim 25, wherein the haptic feedback is generated in response to a position of the vehicle relative to the locations of the road features identified by the data elements.

27. The system of claim 25, wherein the haptic feedback is generated through a steering wheel, a brake pedal, or a seat.

28. The system of claim 13, wherein the driver assist subsystem generates a warning based on a position of the vehicle relative to the locations of the road features identified by the data of the geospatial database.

29. The system of claim 28, wherein the warning is at least one of a visual warning, an audio warning, a tactile warning, and a haptic warning.

30. The system of claim 13, wherein the haptic feedback includes at least one stimulus applied to the driver of the vehicle.

31. The system of claim 30, wherein the stimulus includes at least one of a vibration, a force, a torque, and a motion.

32. The system of claim 13, including a radar subsystem configured to detect objects in a vicinity of the vehicle and pass a location of the detected objects to the driver assist subsystem.

33. A geospatial database management system accessible by components of a motorized vehicle, the system comprising a geospatial database including data elements identifying a plurality of road features of a tangible road and locations of the road features, the road features including lane boundaries of a vehicle lane of the road that are displaced from each other in a widthwise direction that is transverse to the road and extend in a lengthwise direction along the road.

34. The system of claim 33 including a data storage medium supported by the motorized vehicle, wherein the data elements are stored on the data storage medium.

35. The system of claim 33, wherein the locations of the road features identified by the data elements have an accuracy of approximately one decimeter or less.

36. The system of claim 33, wherein the road features include road boundaries that are proximate side edges of the road.

37. The system of claim 33, wherein the road features correspond to line markings on the road.

38. The system of claim 37, wherein the line markings are selected from a group consisting of a center line marking on the road and a lane boundary line marking on the road.
